(19) United States
(12) Patent Application Publication
(10) Pub. No.: US 2022/0402545 A1
(43) Pub. Date: Dec. 22, 2022

(54) STEERING GEAR APPARATUS FOR A MOTOR VEHICLE

(71) Applicant: ZF FRIEDRICHSHAFEN AG, Friedrichshafen (DE)

(72) Inventors: David VOPEL, Ravensburg (DE); Thorsten HESTERMEYER, Leverkusen (DE)

(21) Appl. No.: 17/840,818

(22) Filed: Jun. 15, 2022

(30) Foreign Application Priority Data
Jun. 17, 2021 (DE) 102021206201.6

(51) Int. Cl. B62D 5/30; B62D 5/09

(52) U.S. Cl. CPC B62D 5/30; B62D 5/09

(57) ABSTRACT

A steering gear apparatus (2) for a motor vehicle (1), comprising a hydraulic steering gear (11) and an electromechanical actuator (7) which is configured to actuate a working valve (10) of the hydraulic steering gear, it being possible for hydraulic fluid to be conducted out of a fluid reservoir (14) selectively into one of at least two working spaces (12) of the hydraulic steering gear (11) in a manner which is dependent on a position of the working valve (10), the steering gear apparatus (1) having a fallback device (16) which is configured, in particular in emergency operation of the steering gear apparatus (2), to selectively conduct hydraulic fluid into one of the at least two working spaces (12) independently of the position of the working valve (10).

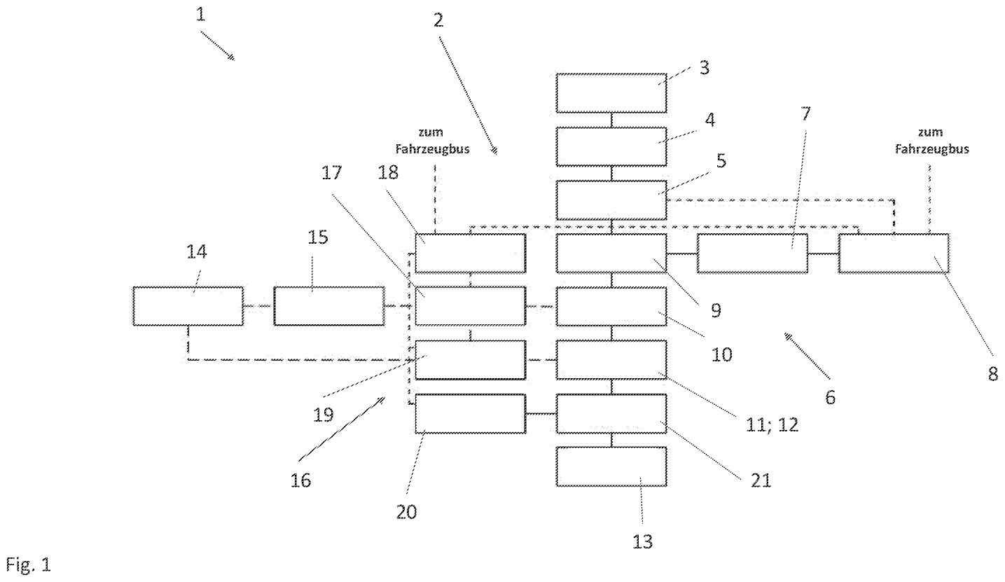

### TECHNICAL FIELD

The invention relates to a steering gear apparatus for a motor vehicle, comprising a hydraulic steering gear and an electromechanical actuator which is configured to actuate a working valve of the hydraulic steering gear, it being possible for hydraulic fluid to be conducted out of a fluid reservoir selectively into one of at least two working spaces of the hydraulic steering gear in a manner which is dependent on a position of the working valve.

### BACKGROUND

Gear apparatuses of this type for motor vehicles which make a steering operation of the motor vehicle hydraulically possible in a manner which is dependent on the position of the working valve, and, in particular, set a wheel angle of the steerable wheel of the motor vehicle hydraulically, are known in principle from the prior art. Here, a change in the position of the gear input shaft and, as a consequence, of the operating valve is usually performed by way of the electromechanical actuator in a manner which is dependent on a steering movement of the steering element of a user or some other steering angle or wheel angle specification, for example from a control unit, in order thus to correspondingly actuate the steering gear by way of a corresponding pressure build-up in the hydraulic fluid in the working spaces.

In a manner which is dependent on how the wheel angle is to be set, the electromechanical actuator therefore brings about an actuation, provided for this purpose, of the working valve via the rotation of the gear input shaft, in order to set the desired quantity of hydraulic fluid or a desired pressure of the hydraulic fluid in one of at least two working spaces, such that the steering gear can be loaded hydraulically as a result, which steering gear in turn sets the wheel angle. If a fault occurs in the steering gear apparatus, if the electromechanical system, for example the electromechanical actuator or a further component of the electromechanical system is affected, in particular, it is known, furthermore, that the electromechanical system can no longer contribute to the assistance. If there is a direct mechanical intervention by the steering element on the working valve, the user of the motor vehicle has to apply a corresponding force or a corresponding torque to the steering element, in particular the steering wheel, in order nevertheless to move the gear input shaft and therefore the working valve into the required position.

In particular in the area of heavy utility vehicles, this can be carried out only to a restricted extent or with great effort, in particular depending on the driving situation. In fault situations of this type, however, the motor vehicle is nevertheless to remain controllable at least until it is in a safe driving state, in particular in such a way that the steerability or the steering capability of the motor vehicle is maintained at least until below a certain speed value. In autonomous operating situations, in which the steering gear apparatus is not controlled by way of the input of a user, for example in such a way that the user does not operate the steering element in order to bring about the mechanical intervention on the position of the working valve, but rather the actuation of the working valve takes place in a purely electromechanical manner based on the actuation of a control unit, there is ultimately no longer a possibility in a fault situation of this type to maintain the position of the working valve and therefore the steerability of the motor vehicle.

### SUMMARY

The invention is based on the object of specifying a steering gear apparatus for a motor vehicle, which steering gear apparatus is improved in comparison with this.

The object is achieved by way of a steering gear apparatus with the features of claim 1. Advantageous refinements are the subject matter of the subclaims.

As described, the invention relates to a steering gear apparatus for a motor vehicle, which steering gear apparatus comprises a hydraulic steering gear and an electromechanical actuator which is configured to actuate a working valve of the hydraulic steering gear. Therefore, it is possible for hydraulic fluid to be conveyed into one of at least two working spaces in a manner which is dependent on how the electromechanical actuator actuates the working valve, or the pressure of the hydraulic fluid in the working spaces can be set, with the result that the hydraulic steering gear can be actuated as a result, in order to set a wheel angle. In normal operation, the setting of the wheel angle therefore takes place at least partially by way of the setting on the part of the electromechanical actuator which can possibly be assisted by way of a steering movement by the user.

The invention is based on the finding that the steering gear apparatus has a fallback device which is configured, in particular in emergency operation of the steering gear apparatus, to selectively conduct hydraulic fluid into one of the at least two working spaces independently of the position of the working valve. In other words, it is proposed that, in normal operation (as has been known up to now), the setting of the wheel angle or the actuation of the hydraulic steering gear can take place by way of the electromechanical actuator, by the latter guiding the working valve via the gear input shaft into a corresponding position, with the result that hydraulic fluid can be conducted in a targeted manner into one of the working spaces or hydraulic fluid can be conducted out of one of the working spaces. In a manner which is dependent on its position, the working valve can therefore convey a fluid reservoir, for example a volume, in which hydraulic fluid is received, in particular with loading by way of a pressure generation device, into one of the working spaces or can convey it out of one of the working spaces, or can distribute hydraulic fluid in any desired combination to the at least two working spaces.

If a fault occurs in the electromechanical system, for example in the electromechanical actuator, a gear which is assigned to the actuator, a control unit or a sensor which is assigned to the electromechanical actuator, the fallback device can take over the control of the hydraulic steering gear. Here, in particular, the fallback device is configured to conduct hydraulic fluid, in particular directly, into one of the described at least two working spaces and correspondingly also to remove or to allow hydraulic fluid to flow out from at least one of the working spaces. The steering gear apparatus can therefore switch over into the described emergency operation, and can ultimately bypass the actuation by way of the electromagnetic actuator and, instead, can carry out a direct influence on the conveying of the hydraulic fluid or the pressure control of the hydraulic fluid in the working spaces of the hydraulic steering gear. The electromechanical system can also be switched off completely in emergency operation.

Within the context of this application, the electromechanical actuator can also be understood to be a constituent part of an electromechanical superimposed system which, as has been described above, generates torque by way of the actuator, which torque can be brought about on the working valve, in order to set the position of the working valve. By way of the working valve, hydraulic fluid can ultimately be conducted into the working spaces, in order to control the hydraulic steering gear. The hydraulic steering gear is in turn connected to further gear elements which are known in principle from the prior art and will not be described in greater detail here. Corresponding gear elements can be, for example, a steering rod, track rod, a track rod arm and the like, which bring about a mechanical transmission to the wheel or the wheel suspension system, with the result that the desired wheel angle can be set.

In this way, the fallback device describes a separate system which does not utilize the components of the electromechanical system, in particular does not have any influence on the electromechanical actuator, but is rather present in a completely separate manner therefrom. As a result of the switchover into emergency operation, recourse is not made to any of the components of the electromechanical actuator, but rather a direct actuation of the working spaces is performed.

The fallback device has, in particular, a switchover valve which is configured to establish a fluidic connection between the fluid reservoir and the working valve in normal operation, and to establish a fluidic connection between the fluid reservoir and the working spaces in emergency operation. A switchover can therefore fundamentally be carried out between normal operation and emergency operation by way of the switchover valve. To this end, in normal operation, the fluid reservoir is connected to the working valve in such a way that the hydraulic steering gear can be operated by way of a corresponding positioning or actuation of the working valve by the electromechanical actuator. If emergency operation has to be used, in particular on account of a fault in the electromechanical system, in particular the actuation of the electromechanical actuator or the electromechanical actuator itself, the switchover valve switches over, with the result that there is no longer a fluidic connection between the fluid reservoir and the working valve. Instead, the switchover valve establishes a fluidic connection between the fluid reservoir and the working spaces.

In other words, the switched-over switchover valve can perform direct operation or a direct supply of the working spaces independently of the position of the working valve. For example, a pressure generation device can remove hydraulic fluid directly from the fluid reservoir and can convey it directly into one of the at least two working spaces, and can conduct hydraulic fluid out of one of the working spaces directly into the fluid reservoir, without there having to be a steering angle specification at the gear input shaft of the hydraulic steering gear to this end. The working valve can comprise, for example, a rotary slide valve which ensures the supply of the hydraulic fluid into the working spaces in a manner which is dependent on its switching position by way of the electromechanical actuator. If the switchover valve is switched over to emergency operation, the position of the working valve is irrelevant, since the working spaces are supplied directly from the fluid reservoir. In other words, the switchover valve brings about a “bypass”, since the working valve is bypassed. The switchover valve can be configured, in particular, as a 4/2-way valve. The switchover valve is assigned a corresponding control device which can implement, in particular, steering commands, that is to say control commands for the actuation of the hydraulic steering gear, in order to ensure a corresponding supply of the working spaces with the hydraulic fluid.

As has been described above, the term “supply” of the working spaces is understood to mean the build-up of a pressure with the hydraulic fluid in the working space and a corresponding discharge of hydraulic fluid from the respective other working space. A “fluid reservoir” is understood to mean any arbitrary volume, in which hydraulic fluid can be provided, for example can be conveyed by way of a pump into the working spaces, or can be removed passively or actively from the working spaces and can be buffer-stored.

Furthermore, the switchover valve or an additional regulating valve can be configured to regulate, in particular in an infinitely variable manner, the pressure of the hydraulic fluid which prevails in the working spaces from the fluid reservoir. As has been described, the pressure in the working spaces acts ultimately on the hydraulic steering gear, with the result that the hydraulic steering gear sets the wheel angle in a manner which is dependent on the quantity or the pressure of the hydraulic fluid in the working spaces. By virtue of the fact that the pressure in the working spaces can be regulated, the wheel angle can be set by way of the hydraulic steering gear. Here, in particular, an infinitely variable pressure regulation is preferred, in order for it to be possible for the wheel angle to be correspondingly set in an infinitely variable manner. As has already been described, it is necessary to this end to apply a certain pressure of the hydraulic fluid to one of the working spaces and to accordingly discharge pressure from the at least one further working space.

The regulating valve can be configured, for example, as a 4/3-way valve. An integration of the switchover valve and the regulating valve into a common valve is likewise possible. Furthermore, the switchover valve can be configured in such a way that it can assume both the switchover task and the regulating task. Within the context of this application, any desired refinement of the valves is fundamentally possible, with the result that they can be provided in any desired type, number and combination. The embodiments which are described herein, in particular in relation to the valves, are therefore to be understood to be merely exemplary and variable in relation to the specific application.

The steering gear apparatus can have a fallback control device or can be coupled to a fallback unit of a control device which is configured to generate a control signal for an actuation of the switchover valve and/or the regulating valve in emergency operation. In accordance with this refinement, the fallback device can be assigned a separate fallback control device, or the steering gear apparatus can have a separate fallback control device of this type for the fallback device. The control of the fallback device can also be performed in a fallback unit which forms a constituent part of a further control device, for example of a central control unit. The fallback control device and fallback unit are configured to generate a control signal in emergency operation, which control signal permits an actuation of the switchover valve or the regulating valve. The control signal can either be tapped off via a sensor system by a steering element, for example a torque sensor and/or an angle sensor which register/registers a steering movement on the part of the user and generate/generates a corresponding control signal. It is likewise possible that the control signal is generated in the control unit, for example within the context of autonomous driving operation.

Therefore, the fallback device can be considered to be what is known as a “back-up system” which comprises a dedicated control device or a unit within another control device. Furthermore, the fallback device comprises a dedicated hydraulic circuit and preferably a dedicated pump or a pump which is assigned to the fallback unit and can generally be called a pressure generation device. By way of the pressure generation device, the fallback device is configured to convey hydraulic fluid into the working spaces, as has been described above.

The fallback device can have, in particular, a first and/or a second pressure generation device for conveying hydraulic fluid, it being possible for a first pressure generation device to be engine-operated and for a second pressure generation device to be passively operated, in particular to be gear-operated or to be operated by means of an electric energy store. The corresponding pressure generation device or pump can also be called a power steering pump. The first pressure generation device or pressure generation device of the first type which is configured for active pressure generation can be driven, in particular, by way of the engine of the motor vehicle. Therefore, the first pressure generation device can be operated predominantly when the engine of the motor vehicle can be operated, and can perform a corresponding pressure generation in the hydraulic fluid or convey hydraulic fluid under pressure into the working spaces.

The second pressure generation device can be operated passively; that is to say, the second pressure generation device can ultimately be operated independently of an engine operation of the motor vehicle. The second pressure generation device can be, for example, gear-operated or operated by means of an electric energy store. This affords the advantage, in particular, that, in the case of a failure of the engine system of the motor vehicle, that is to say in an operating state in which the engine of the motor vehicle fails, generating pressure and conveying hydraulic fluid out of the fluid reservoir into the working spaces is nevertheless possible. To this end, the second pressure generation device is coupled to the gear, or has an energy store which is separate or is present in the motor vehicle and can provide energy, in order to operate the second pressure generation device.

Therefore, the term “operated passively” relates to operation of the second pressure generation device independently of the engine system of the motor vehicle. This affords the advantage, in particular, that the second pressure generation device can be operated even when there is a disruption in engine operation of the motor vehicle, in particular by way of the rotational movement of gear elements in the gear of the motor vehicle or by way of a dedicated electric energy store or the energy store of the motor vehicle, with the result that sufficient pressure can ultimately still be generated to provide the hydraulic fluid for the control of the hydraulic steering gear.

The second pressure generation device is, in particular, to be called self-sufficient, since it ensures a steering capability of the motor vehicle even without engine operation. Here, in particular, a speed value can be defined, up to which a defined steering assistance is possible or a steering capability of the motor vehicle can be maintained in a defined manner. A speed limit of this type can be defined, for example, as 10 km/h. The second pressure generation device is therefore designed in such a way that steering assistance is possible even in the case of a malfunctioning engine of the motor vehicle, for example by way of gear operation or by way of a dedicated electric energy store. If the speed of the motor vehicle falls below the defined limit value, it is to be assumed that the motor vehicle can be braked and a restricted steering capability is sufficient until final standstill.

Furthermore, the steering gear apparatus can have a detection device which is configured to transmit a steering angle signal, in particular from a steering angle sensor, to a control device which is assigned to the fallback device, the fallback device being configured to load the working spaces with hydraulic fluid in a manner which is based on the steering angle signal. The steering angle signal can also be replaced by a wheel angle signal, since ultimately the specification of the steering angle leads to a corresponding setting of a wheel angle. Therefore, within the context of this application, the terms “steering angle signal” and “wheel angle signal” can ultimately be swapped or used synonymously. In accordance with the described refinement, a steering angle sensor is provided which indicates in which direction the user wishes to steer or which wheel angle is to be set at the wheel of the motor vehicle. It is likewise possible for the steering angle to be detected by a control device, for example within the context of autonomous driving operation, since, in this case, the control device specifies in which direction the wheels are to be steered or which wheel angle is to be set.

Here, in particular, continuous monitoring of the electromechanical steering system can take place, possibly by way of a separate control unit. The control device can gather a setpoint steering angle from a central control unit via a bus system of the vehicle. The described setpoint steering angle can be converted via suitable functions into a motor current to be actuated. Ultimately, an actual torque is therefore generated by way of the electromechanical actuator. The actual torque can be applied via a gear to the gear input shaft of the hydraulic steering gear and the working valve, in order to set the desired wheel angle. The action of the actual torque on the hydraulic steering gear has been described above and is well known within the context of customary components and boosting mechanisms from the prior art.

In accordance with a further refinement of the steering gear apparatus, the detection device can be assigned at least one steering angle sensor which is arranged on a steering element and/or a detection element which is coupled to the steering element, and/or the detection device can be assigned at least one steering angle sensor which is arranged at an output of the steering gear. The refinement therefore makes the detection of a steering angle by way of a steering angle sensor possible.

Here, the user of the motor vehicle can steer himself/herself, and the steering angle which is specified at a steering element, in particular a steering wheel, can be detected directly. At the same time, it is likewise possible for a steering angle sensor to be provided at the gear output of the steering gear in addition or as an alternative. Ultimately, the steering angle can be detected as a result, which steering angle the user wishes to set and which steering angle is actually set at the gear output. The difference can be formed between the detected setpoint steering angle which the user wishes to set and the real actual steering angle which prevails at the gear output, and the difference can be corrected correspondingly. The steering angle sensor which is detected at the gear output can therefore be arranged as close to the wheel as possible, in order to ensure that the actual steering angle is really set as wheel angle.

Furthermore, the steering gear apparatus can have at least one monitoring device which is configured to monitor the functional capability of at least one component of the steering gear apparatus. The monitoring device can be configured, for example, for self-monitoring which monitors status signals of the individual components of the steering gear apparatus continuously or at fixed time intervals. For example, the electromechanical system or the electromechanical actuator, a control device of the electromechanical system and further components, can transmit operating states to an integrated control device. External monitoring is likewise possible, with the result that the steering gear apparatus or the monitoring device of the steering gear apparatus reports the current operating state by way of a report to an external control unit. It can be provided here in both cases that, in the case of a deviation of the operating state from a setpoint operating state or in the case of an absence of the report of the operating state, for example for three switching cycles, the emergency operation can be carried out or triggered. This can ensure that a switchover to emergency operation, as has been described above, can be carried out in the case of a fault or deviation which occurs.

Furthermore, the steering gear apparatus can be developed in such a way that the fallback device is configured to carry out emergency operation in an autonomous driving mode of the steering gear apparatus. As described, as an alternative to the specification of the steering angle by way of a user, namely by way of input at a steering element, it is likewise possible that the driving operation is carried out autonomously or partially autonomously. In autonomous driving operation of this type, it is assumed that the wheel angle is to be set autonomously or automatically. To this end, a control device can specify a setpoint steering angle which is to be implemented by way of the hydraulic steering gear and leads to a setting of the desired wheel angle. In the autonomous case, there is therefore ultimately no direct continuous mechanical connection from a steering element to the hydraulic steering gear, but rather the setting of the steering angle is based, in normal operation, on the fact that the electromechanical actuator actuates the gear input shaft of the hydraulic steering gear and the working valve correspondingly, in order to act on the hydraulic steering gear by way of the introduction of hydraulic fluid into the working spaces, and therefore to set the wheel angle.

In autonomous driving operation of this type, the malfunction of the electromechanical system or a fault in the electromechanical system, in particular a software fault, a fault in the control device or of the electromechanical actuator or a fault in the generation of the steering angle signal, therefore leads to there no longer being a steering capability in autonomous driving operation. One possible case can also relate to a fault in a mechanical component, for example in the region of the working valve or its actuation, for example of a torsion bar which transmits the torque from an electromechanical actuator to the working valve.

If a fault is detected which occurs in autonomous driving operation, the fallback device is configured, as described above, to perform a direct feed or discharge of hydraulic fluid into/from the working spaces by way of switching over by means of the switchover valve, and therefore to bypass the electromechanical actuator and the electromechanical actuation completely. As a result of the completely self-sufficient system of the fallback device, recourse is therefore not made to other components of the malfunctioning system, but rather a “bypass” is produced which therefore makes a redundant and independent actuation in the case of a fault possible.

In addition, the invention relates to a motor vehicle which comprises an above-described steering gear apparatus. The motor vehicle can fundamentally be configured as a passenger car or truck, it being possible for the described steering gear apparatus to advantageously be used, in particular, for comparatively heavy utility vehicles. All of the advantages, details and features which have been described in relation to the steering gear apparatus can be transferred completely to the motor vehicle.

### BRIEF DESCRIPTION OF THE DRAWINGS

The invention will be described in the following text on the basis of one exemplary embodiment with reference to the FIGURE. The FIGURE is a diagrammatic illustration and shows a detail of a motor vehicle with a steering gear apparatus.

### DESCRIPTION

The FIGURE shows a motor vehicle 1 in a diagrammatic detail, in particular in the region of a steering gear apparatus 2. In this exemplary embodiment, the steering gear apparatus 2 has a steering element 3, for example a steering wheel, and a steering column 4, on which a detection device 5 is arranged which has, for example, a torque sensor and an angle sensor, which angle sensor is configured to detect a steering angle by which the steering element 3 is deflected. The torque sensor can detect a torque which is brought about on the steering element 3 by way of the user. The motor vehicle 1 can fundamentally also be configured for autonomous steering or lateral control, with the result that the steering element 3, the steering column 4 and the detection device 5 are considered optional and can be dispensed with if the motor vehicle 1 is steered in a purely autonomous manner.

Furthermore, the steering gear apparatus 2 has an electromechanical system 6 which has an electromechanical actuator 7, a control device 8 and a transmission gear 9. The actuator 7 can fundamentally be of electromechanical configuration, in order to transmit or to generate a torque. The control device 8 can be connected to a bus of the motor vehicle 1, for example of a central control unit which is not shown in greater detail. Furthermore, the control device 8 can receive the signals of the detection device 5 or can request them.

The actuator 7 is connected via the transmission gear 9 to a working valve 10, for example via a torsion bar. The working valve 10 is in turn connected to a hydraulic steering gear 11, and can selectively fill working spaces 12 (not shown in greater detail) of the hydraulic steering gear 11. The hydraulic steering gear 11 subsequently brings about the setting of a wheel angle at the steerable wheels 13 of the motor vehicle 1.

The actuator 7 can therefore generate a torque, in particular in a manner which is based on an actuation by way of the control device 8 which in turn receives the steering angle, set at the steering element 3 by way of the user, from the detection device 5. The torque from the actuator 7 can therefore be transmitted via the transmission gear 9 to the working valve 10, with the result that the working spaces 12 can be filled with hydraulic fluid from the fluid reservoir 14 in accordance with the steering angle. To this end, a pressure generation device 15 can be actuated, in order to convey hydraulic fluid under pressure into one of at least two working spaces 12, depending on how the working valve 10 is actuated. Here, hydraulic fluid can escape from the respective other working space 12 back into the fluid reservoir 14.

As has been described, the motor vehicle 1 can have autonomous lateral control, with the result that the steering element 3, the steering column 4 and the detection device 5 are dispensed with or are without function in the autonomous operating mode. The description is otherwise transferable, the required steering angle or wheel angle being fed from the bus of the motor vehicle 1, in particular from a control unit, to the control device 6.

If a fault occurs in the electromechanical system 6, for example in the control device 8, the actuator 7, the transmission gear 9 or the working valve 10, emergency operation is triggered, for which purpose the steering gear apparatus 2 has a fallback device 16.

The fallback device 16 has a switchover valve 17 which is fundamentally configured to conduct the fluid flow or fluid path from the fluid reservoir directly to the at least two working spaces 12. In other words, the switchover valve 17 represents a “bypass”, since the hydraulic fluid is no longer conducted from the fluid reservoir 14 to the working valve 10, but rather the working valve 10 is bypassed. In the exemplary embodiment which is shown, the fallback device 16 has, furthermore, a fallback control device 18 which is configured to actuate the switchover valve 17. If, for example, a fault is detected in the electromechanical system 6, either the control device 8 or a central control unit of the motor vehicle 1 of the fallback control device 18 can announce the fault. In this case, the electromechanical system 6 can be switched off. The control devices 8, 18 might also fundamentally be dispensed with, and the corresponding control signals might be generated directly at a central control unit of the motor vehicle 1.

Furthermore, it is apparent from the FIGURE that the fallback device 16 has a regulating valve 19 which is configured to regulate the pressure of the hydraulic fluid in the at least two working spaces 12 in an infinitely variable manner, that is to say to load at least one working space 12 with hydraulic fluid in a targeted manner, with the result that a defined pressure is generated therein, and to discharge hydraulic fluid in a defined manner from the at least one further working space 12 and to feed it to the reservoir 14 again. A corresponding control of the pressure generation device 15 is likewise possible here, it also being possible as an alternative for it to generate a pressure which is subsequently distributed through the regulating valve 19. The regulating valve 19 and the switchover valve 17 can fundamentally also be integrated into a single valve unit. The switchover valve 17 can otherwise be configured, for example, as a 4/2-way valve and the regulating valve 19 can be configured as a 4/3-way valve. In general, any desired combination of a plurality of valves can be used.

In the described emergency operation, the required wheel angle is therefore set at the wheels 13 by virtue of the fact that the control signal (for example, generated by way of the fallback control device 18) is routed to the switchover valve 17 which feeds the hydraulic fluid, which can be conveyed out of the reservoir 14, via the regulating valve 19 to the working spaces 12. As has been described above, the hydraulic steering gear 11 can actuate the wheels 13 by the defined wheel angle by way of the corresponding setting of the necessary pressure in the working spaces 12. Furthermore, the fallback device 16 is assigned a detection device 20, for example an angle sensor. The latter can access a gear output 21 of the hydraulic steering gear 11 or can tap off a steering angle there or can detect the wheel angle directly. As a result, in particular, it can be determined whether the desired steering angle or wheel angle is actually being implemented. If a steering element 3 is used to fix the steering angle or a user carries out the steering operation via the steering element 3, the steering angle or wheel angle determined on the part of the detection device 5 and the steering angle/wheel angle determined on the part of the fallback detection device 20 can be compared with one another and it can be determined whether the desired wheel angle is actually being generated.

The fallback device 16 advantageously achieves a situation where the steering gear apparatus 2 remains completely usable and the motor vehicle 1 maintains its steering capability. Here, the fallback device 16 does not make recourse to components of the electromechanical system 6, but rather brings about a direct actuation of the working spaces 12 of the hydraulic steering gear 11. In this way, a fault can occur in any arbitrary components of the electromechanical system 6, with the result that the steering capability of the motor vehicle 1 is maintained completely even in the case of a complete malfunction of the control device 8, the electromechanical actuator 7, the transmission gear 9 or the working valve 10.

A first pressure generation device which is driven, for example, in an engine-operated manner can be used, in particular, as pressure generation device 15. Here, the engine of the motor vehicle 1, that is to say the drive device, can be used via a corresponding gear unit to operate the first pressure generation device, with the result that hydraulic fluid can be conveyed from the fluid reservoir 14 and can be fed to the corresponding working spaces 12. As an alternative or in addition, it is likewise possible that the fallback device 16 has an additional pressure generation device, as second pressure generation device, for example a passively operated pressure generation device. The second pressure generation device can be operated, for example, via a gear of the motor vehicle 1, with the result that, as long as the motor vehicle 1 is in movement, driving the second pressure generation device is possible. The second pressure generation device can likewise be assigned a separate, in particular electric, energy store which can drive the second pressure generation device at least until the motor vehicle 1 can be moved into a safe state.

### LIST OF DESIGNATIONS

1 Motor vehicle

2 Steering gear apparatus

3 Steering element

4 Steering column

5 Detection device

6 Electromechanical system

7 Actuator

8 Control device

9 Transmission gear

10 Working valve

11 Hydraulic steering gear

12 Working space

13 Wheel

14 Fluid reservoir

15 Pressure generation device

16 Fallback device

17 Switchover valve

18 Fallback control device

19 Regulating valve

20 Detection device

21 Gear output

1. A steering gear apparatus (2) for a motor vehicle (1), comprising a hydraulic steering gear (11) and an electromechanical actuator (7) which is configured to actuate a working valve (10) of the hydraulic steering gear, it being possible for hydraulic fluid to be conducted out of a fluid reservoir (14) selectively into one of at least two working spaces (12) of the hydraulic steering gear (11) in a manner which is dependent on a position of the working valve (10), distinguished by a fallback device (16) which is configured, in particular in emergency operation of the steering gear apparatus (2), to selectively conduct hydraulic fluid into one of the at least two working spaces (12) independently of the position of the working valve (10).

2. The steering gear apparatus (2) as claimed in claim 1, wherein the fallback device has a switchover valve (17) which is configured to establish a fluidic connection between the fluid reservoir (14) and the working valve (10) in normal operation, and to establish a fluidic connection between the fluid reservoir (14) and the working spaces (12) in emergency operation.

3. The steering gear apparatus (2) as claimed in claim 1, wherein the switchover valve (17) or an additional regulating valve (19) is configured to regulate, in particular in an infinitely variable manner, the pressure of the hydraulic fluid which prevails in the working spaces (12) from the fluid reservoir (14).

4. The steering gear apparatus (2) as claimed in claim 1, wherein the steering gear apparatus (2) has a fallback control device (18) or is coupled to a fallback unit of a control device which is configured to generate a control signal for an actuation of the switchover valve (17) and/or the regulating valve (19) in emergency operation.

5. The steering gear apparatus (2) as claimed in claim 1, wherein the fallback device (16) is configured by way of a first and/or a second pressure generation device (15) for conveying hydraulic fluid, a first pressure generation device (15) being engine-operated and a second pressure generation device (15) being passively operated, in particular being gear-operated or by means of an electric energy store.

6. The steering gear apparatus (2) as claimed in claim 1, distinguished by a detection device (5, 20) which is configured to transmit a steering angle signal, in particular from a steering angle sensor, to a control device (18) which is assigned to the fallback device (16), the fallback device (16) being configured to load the working spaces (12) with hydraulic fluid in a manner which is based on the steering angle signal.

7. The steering gear apparatus (2) as claimed in claim 6, wherein the detection device (5, 20) is assigned at least one steering angle sensor which is arranged on a steering element (3) and/or a detection element which is coupled to the steering element (3), and/or the detection device (5, 20) is assigned at least one steering angle sensor which is arranged at an output of the steering gear (11).

8. The steering gear apparatus (2) as claimed in claim 1, wherein the steering gear apparatus (2) has at least one monitoring device which is configured to monitor the functional capability of at least one component of the steering gear apparatus (2).

9. The steering gear apparatus (2) as claimed in claim 1, wherein the fallback device (16) is configured to carry out emergency operation in an autonomous driving mode of the steering gear apparatus (2).

10. A motor vehicle (1), comprising a steering gear apparatus (2) as claimed in claim 1.
